(19) United States
(12) Patent Application Publication
(10) Pub. No.: US 2012/0251761 A1
(43) Pub. Date: Oct. 4, 2012

(54) RECORDABLE OPTICAL RECORDING MEDIUM

(75) Inventors: Yung-Hui HUNG, Taipei (TW); Cheng-Pi LEE, Taipei (TW); Min-Hao PAN, Taipei (TW)

(73) Assignee: CMC Magnetics Corporation, Taipei (TW)

(21) Appl. No.: 13/432,024

(22) Filed: Mar. 28, 2012

(30) Foreign Application Priority Data
Mar. 31, 2011 (TW) 100111231

(51) Int. Cl. B32B 3/02

(52) U.S. Cl. 428/64.4

(57) ABSTRACT

A recordable optical recording medium having inorganic films prepared by sputter coating is disclosed. The recordable optical recording medium includes a substrate; one or more film stacked structures sequentially formed on a surface of the substrate to respectively function as an independent recording layer structure and include from top to bottom a reflective film, an upper dielectric film, one or more recording films, a lower dielectric film and a barrier film; an interlayer separating layer located between two adjacent film stacked structures to isolate them from each other; and a ZrO₂-based interface film additionally formed in each of the film stacked structures between the reflective film and the upper dielectric film. With these arrangements, the recordable optical recording medium can have improved environmental resistance and optimized electrical characteristics.

### FIELD OF THE INVENTION

The present invention relates to an optical recording medium, and more particularly to a recordable optical recording medium having an improved multilayer structure.

### BACKGROUND OF THE INVENTION

Optical recording and storage is a process of applying laser technology to record data on an optical recording medium. Most of the currently commercially available inorganic recordable optical recording media similarly include a film stacked structure formed of a barrier film, a reflective film, upper and lower dielectric films, and a recording film located between the two dielectric films. These recordable optical recording media may have two or more layers of such film stacked structure according to the required recording capacity. FIG. 1 shows a prior art recordable optical recording medium including two layers of the film stacked structure. To record data on the optical recording medium with a laser beam at a predetermined writing power, there will be phase change in the recording film to result in different reflectance at zones having and having not data recorded thereon. With such difference in the reflectance, data stored in the optical recording medium can be read out with a laser beam of an appropriate power.

### SUMMARY OF THE INVENTION

For the film stacked structure formed via an inorganic process to have enhanced environmental resistance and to provide stable and good recording quality, it is an object of the present invention to provide a film material that has high stability and high refraction coefficient (n value) for laser pulses to effectively reflect from or transmit through the film material under control, so as to achieve optimized electrical characteristics and form a dense film to protect a recording film on an optical recording medium.

More specifically, the present invention uses a single-layer inorganic material as an interface film for a recordable optical recording medium. When the film having a high n value is irradiated by a laser beam, an interface reaction occurs at the laser irradiated area, i.e. a data recording point on the film, bringing changes in the microstructure and accordingly the reflectance of the film thereat to thereby achieve the purpose of recoding digital signals.

According to the recordable optical recording medium of the present invention, data writing and reading takes place when a laser beam is incident into the recording medium from one side opposite to a substrate. Alternatively, data writing and read can take place when a laser beam is incident into the recording medium from the substrate side if the films in the stacked structure of the recording medium were adjusted in their positions. The recordable optical recording medium of the present invention includes a substrate having continuous spiral grooves formed thereon, and a multilayer structure coated on a surface of the substrate. The multilayer structure includes at least one film stacked structure, which forms an independent recording layer structure. In an embodiment of the present invention, there are a first and a second film stacked structure, each of which includes from top to bottom a reflective film, an interface film, an upper dielectric film, a recording film, a lower dielectric film, and a barrier film.

The present invention further includes an interlayer separating layer located between the two film stacked structures to isolate them from each other, and a light transmitting layer formed on one side of the second film stacked structure opposite to the substrate. The present invention is characterized by the interface film provided in each of the film stacked structures between the reflective film and the upper dielectric film thereof. The interface film has upgraded environmental resistance and improved electrical characteristics to enable optimized manufacturing process. The recording films irradiated by a laser beam will absorb the laser and form changes in its microstructure at the laser irradiated locations, and interface elements mutual diffuse to form a mixed zone. Due to different film structures, the mixed zone as a result of being heated by the laser beam and other non-mixed zones not heated by the laser beam are apparent different in their reflectance. With such difference in the reflectance, it is able to achieve the purpose of recording data on the optical recording medium.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic cross-sectional view showing a multilayer structure of a prior art recordable optical recording medium;

FIG. 2 is a schematic cross-sectional view showing a multilayer structure of a recordable optical recording medium according to a preferred embodiment of the present invention;

FIG. 3 illustrates results from dynamic tests conducted on recordable optical recording media according to the present invention and to the prior art to indicate the relationship between writing power and jitter value thereof;

FIG. 4a is a diagram showing the electrical characteristics of different layers of the recordable optical recording media according to the present invention and to the prior art at different archival lifetime obtained in environmental tests under 70° C. and 80% RH;

FIG. 4b is a diagram showing the electrical characteristics of different layers of the recordable optical recording media according to the present invention and to the prior art at different archival lifetime obtained in environmental tests under 80° C. and 80% RH;

FIG. 4c is a diagram showing the electrical characteristics of different layers of the recordable optical recording media according to the present invention and to the prior art at different archival lifetime obtained in environmental tests under 90° C. and 80% RH;

FIG. 4d is a table comparing the archival lifetime of the recordable optical recording media according to the present invention and to the prior art obtained in environmental tests under different temperatures; and

FIG. 5 is a diagram showing the Natural Logarithm of Archival Lifetime (In hours) vs. Inverse of Absolute Temperature (1/K).

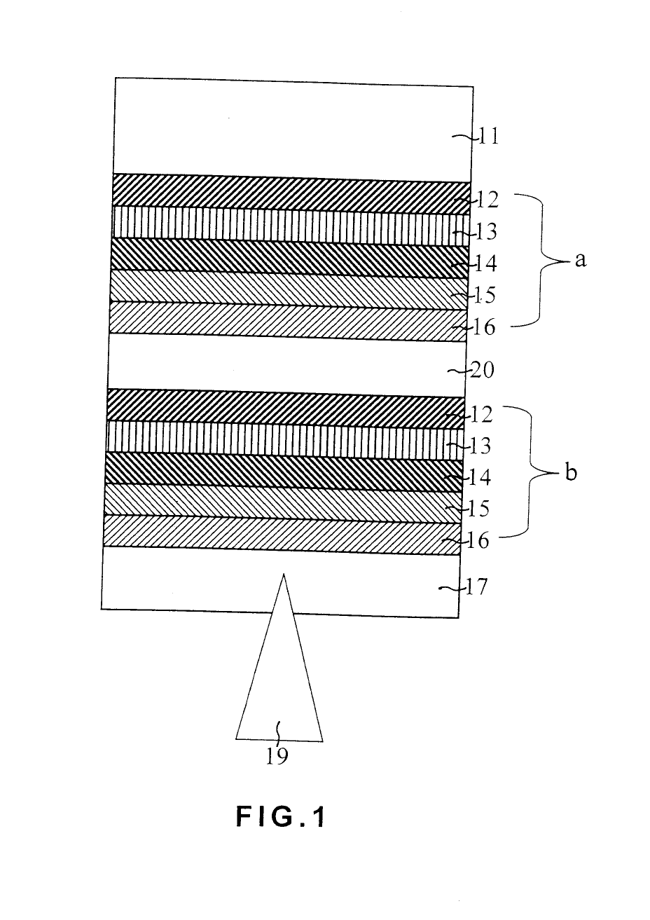

### DETAILED DESCRIPTION OF THE PREFERRED EMBODIMENTS

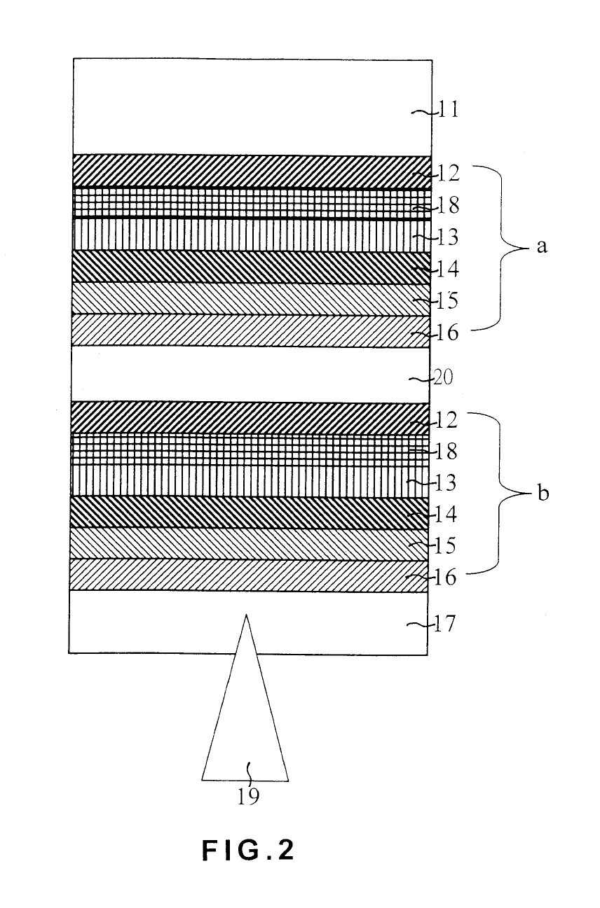

Please refer to FIGS. 2 through 5. The present invention discloses a recordable optical recording medium with interface films to achieve upgraded environmental resistance and optimized electrical characteristics. The recordable optical recording medium according to the present invention allows high-speed and stable writing of data thereinto using a laser beam in the visible light wavelength range, and has increased archival lifetime. It is understood, however, the illustrated embodiment is only for describing a preferred manner of implementing the present invention and not intended to restrict the scope of the present invention in any way.

FIG. 2 is a schematic cross-sectional view showing a multilayer structure of the recordable optical recording medium according to a preferred embodiment of the present invention. As shown, the multilayer structure includes a substrate 11 having continuous spiral grooves formed thereon, a first film stacked structure “a”, an interlayer separating layer 20, a second film stacked structure “b”, and a light transmitting layer 17. The first film stacked structure “a” includes from top to bottom at least a reflective film 12, an upper dielectric film 13, an interface film 18, a recording film 14, a lower dielectric film 15, and a barrier film 16. The second film stacked structure “b” also includes from top to bottom at least a reflective film 12, an upper dielectric film 13, an interface film 18, a recording film 14, a lower dielectric film 15, and a barrier film 16. Data can be read from and written onto the optical recording medium of the above structure by irradiating a laser beam 19 thereon from the side with the light transmitting layer 17.

The substrate 11 is made of an optically transparent material and is able to provide proper mechanical strength. Optically transparent materials available for making the substrate 11 include polycarbonate resin, polymethyl methacrylate, polystyrene resin, polyethylene resin, polypropylene resin and the like. The substrate 11 is preformed with grooves and lands. These grooves and lands function as guide tracks for the laser beam 19 and as data recording positions when recording or reading data onto or from the recordable optical recording medium.

The reflective film 12 can be made of a material selected from the group consisting of gold (Au), silver (Ag), molybdenum (Mo), aluminum (Al), titanium (Ti), tantalum (Ta), neodymium (Nd), bismuth (Bi), and any alloys thereof; and has a thickness ranged between 5 nm and 300 nm.

The upper dielectric film 13 and the lower dielectric film 15 are made of a dielectric material selected from the group consisting of zinc sulfide-silicon dioxide (ZnS—SiO₂), silicon nitride (SiN), germanium nitride (GeN), silicon carbide (SiC) and the like; and respectively have a thickness ranged between 1 nm and 300 nm. Both the upper and the lower dielectric film 13, 15 can be a single-layer film or a multilayer film of any of the above materials.

The interface film 18 is made of a ZrO₂-based composite material and has a thickness ranged between 1 nm and 300 nm.

The recording film 14 is a single target material made of a material selected from the group consisting of copper (Cu), silicon (Si) and chromium (Cr), and has a thickness ranged between 3 nm and 50 nm.

The barrier film 16 is made of a silicon oxynitride material (SiON) and has a thickness ranged between 3 nm and 50 nm.

The light transmitting layer 17 is an ultraviolet-curing resin for keeping the films and layers of the optical recording medium in a stable state by protecting them against wearing, moisture-caused deterioration, or oxidation due to exposure to air.

An experimental example of the present invention is described below.

Prepare a Blu-ray disc (BD-R) substrate 11 of 1.1 mm in thickness and having grooves and lands formed thereon at a track pitch of 0.32 μm. A first film stacked structure “a” is formed on a surface of the substrate 11 by way of magnetic sputter coating in the following steps: (1) coating a silver reflective film 12 of 100 nm in thickness on one surface of the substrate 11; (2) coating a ZrO₂-based material of 4 nm in thickness on the reflective film 12 to form an interface film 18; (3) coating a ZnS—SiO₂ upper dielectric film 13 of 14 nm in thickness on the interface film 18; (4) forming a recording film 14 of 14 nm in thickness on the upper dielectric film 13; (5) coating a ZnS—SiO₂ lower dielectric film 15 of 30 nm in thickness on the recording film 14; and (6) forming a SiON barrier film 16 of 10 nm in thickness on the lower dielectric film 15.

After the forming of the first film stacked structure “a” by means of sputter coating is completed, coat an interlayer separating layer 20 of 25 μm in thickness on the barrier film 16 for isolating the first film stacked structure “a” from a second film stacked structure “b”, which will be subsequently formed on the interlayer separating layer 20. The second film stacked structure “b” is formed by way of sputter coating in the following steps: (1) coating a silver alloy reflective film 12 of 4 nm in thickness on a surface of the interlayer separating layer 20 opposite to the barrier film 16; (2) coating a ZrO₂-based material of 4 nm in thickness on the reflective film 12 to form an interface film 18; (3) coating a ZnS—SiO₂ upper dielectric film 13 of 10 nm in thickness on the interface film 18; (4) forming a recording film 14 of 14 nm in thickness on the upper dielectric film 13; (5) coating a ZnS—SiO₂ lower dielectric film 15 of 30 nm in thickness on the recording film 14; and (6) forming a SiON barrier film 16 of 10 nm in thickness on the lower dielectric film 15. Finally, coat a light transmitting layer 17 of 0.1 mm in thickness on the barrier film 16 of the second film stacked structure “b” to complete a disc as an experimental example of the recordable optical recording medium of the present invention. The completed multilayer structure of the above experimental example is shown in FIG. 2.

An atomic force microscopy (AFM) and an optical measuring apparatus ETA-RT are used to observe the thickness of the sputter coated films; and a Pulstec ODU-1000 dynamic tester is used to conduct a dynamic analysis on the disc of the above experimental example with a writing power ranged between 10 mW and 22 mW, a laser wavelength X of 405 nm, a numerical aperture NA of 0.85, and different recording velocities of 4.92 m/s, 9.84 m/s, 19.68 m/s and 29.52 m/s corresponding to BD-R 1×, 2×, 4×, and 6× recording speed, respectively.

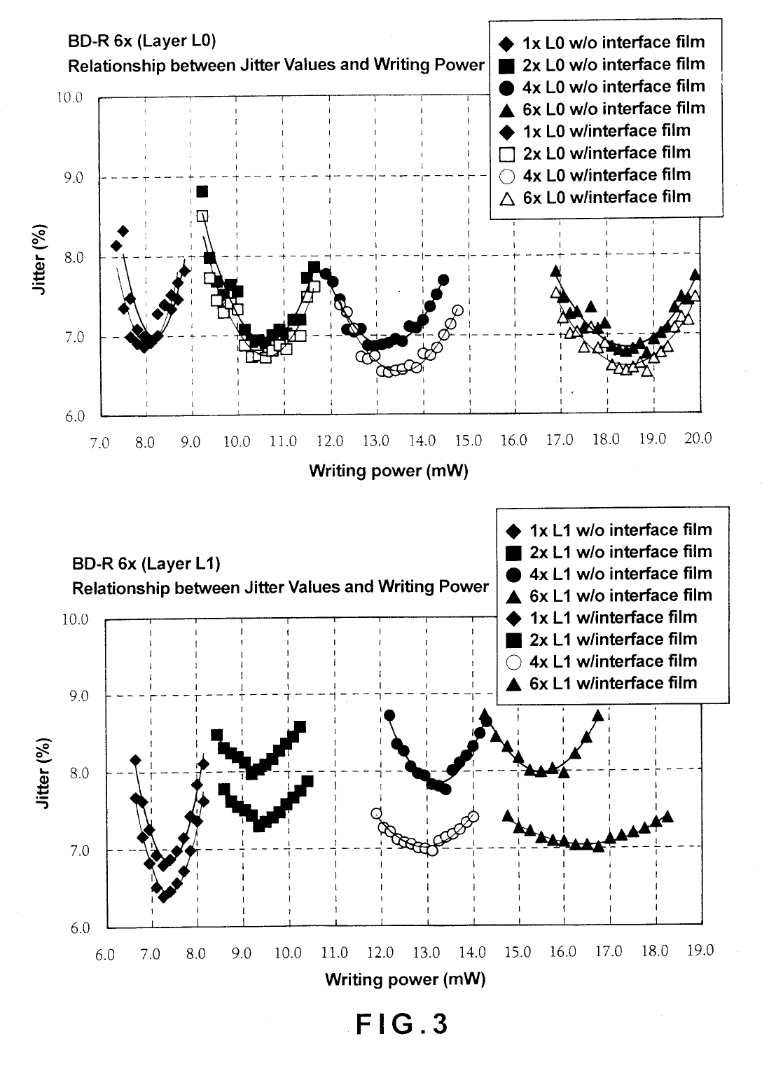

As can be seen from the test results shown in FIG. 3, with an interface film 18 additionally formed between the reflective film 12 and the upper dielectric film 13 in each of the first and the second film stacked structure “a” and “b”, the recordable optical recording medium of the present invention presents electrical characteristics superior to those of a prior art recordable optical recording medium without interface films at any of the 1×, 2×, 4× and 6× recording velocities. Further, results from the dynamic tests conducted on the recordable optical recording media according to the present invention and to the prior art as shown in FIG. 3 indicate that the relationship between the jitter value and the writing power of the present invention allows wide intervals suitable for normal data writing to meet the BD-R recording requirements. Therefore, the recordable optical recording medium of the present invention is proven to be practical for use.

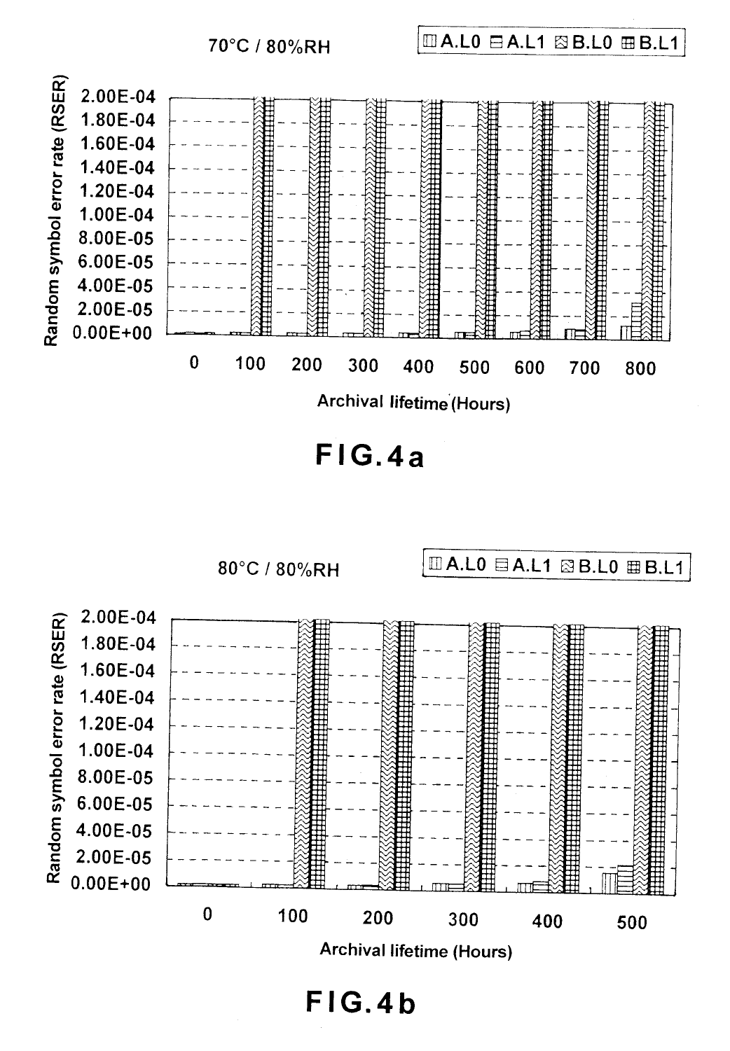

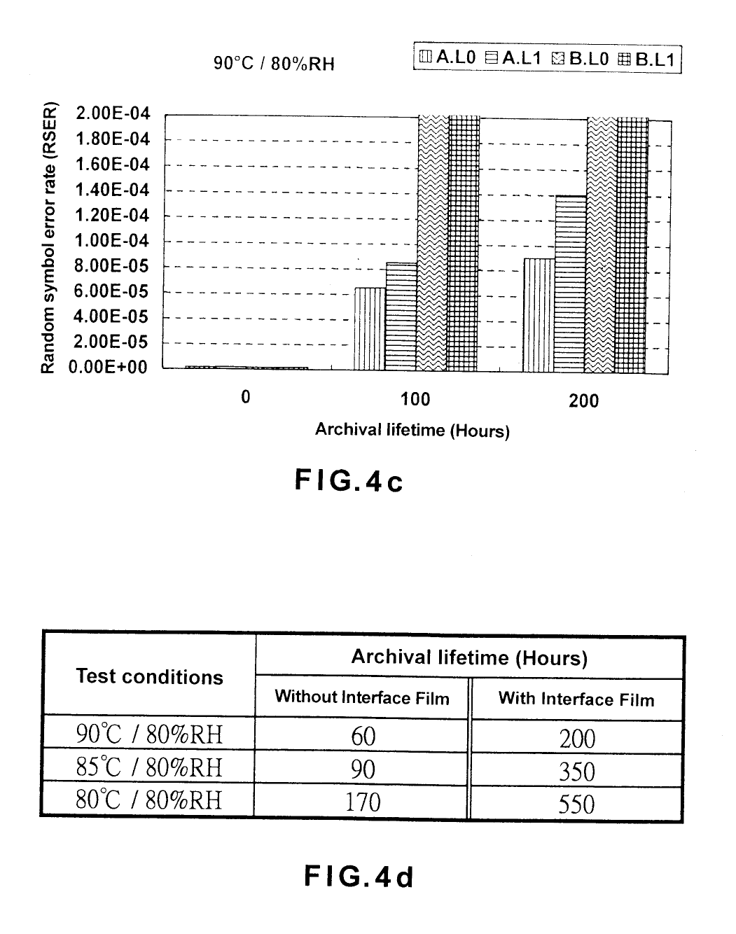

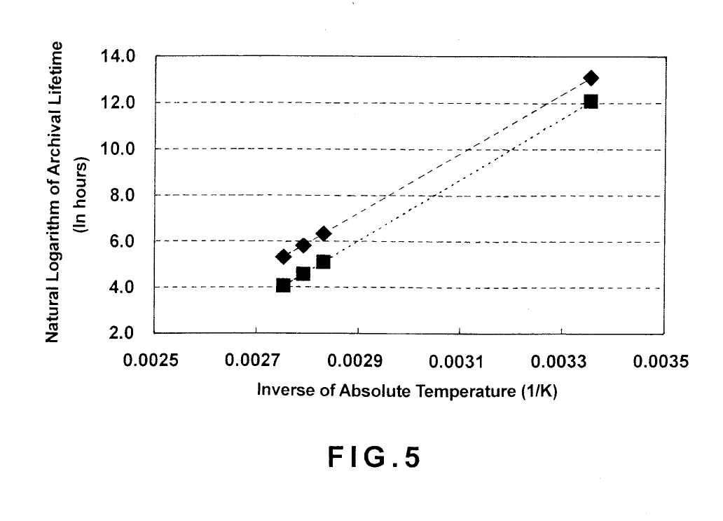

The recordable optical recording medium of the present invention is also subjected to environmental tests under different temperatures and a specific relative humidity (RH), including weather resistance tests under 70° C. and 80% RH, 80° C. and 80% RH, and 90° C. and 80% RH corresponding to the standard of random symbol error rate (RSER<0.0002) as required by the BD specifications. Please refer to FIGS. 4a-4c that are diagrams showing the electrical characteristics of different layers of the recordable optical recording media according to the present invention and to the prior art at different archival lifetime in hours obtained in the environmental tests under 70° C/80 % RH, 80° C/80% RH and 90° C/80% RH, respectively, in which Group A includes double-layer BD-R with interface films according to the present invention and Group B includes prior art double-layer BD-R without interface films. Then, test the recordable optical recording media of the present invention according to the test method for the estimation of the archival lifetime of optical media under ISO 10995. The test results are shown in FIG. 4d and indicate the estimated archival lifetime of the recordable optical recording media of the present invention under 80° C/80% RH, 85° C/80% RH and 90° C/80 % RH can reach 550 hours, 350 hours, and 200 hours, respectively. Please refer to FIG. 5 that is a diagram showing the Natural Logarithm of Archival Lifetime (In hours) vs. Inverse of Absolute Temperature (1/K). From FIG. 5, it is able to derive the estimated archival lifetime at 25° C. of the recordable optical recording media of the present invention is about 490365.6 hours, or about 55 years. That is, the estimated archival lifetime at room temperature of the double-layer BD-R according to the experimental example of the recordable optical recording medium of the present invention is 55 years, which is 2.5 times as high as and apparently superior to the estimated 20-year archival lifetime at room temperature of the prior art double-layer BD-R without interface films.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A recordable optical recording medium, comprising a substrate having continuous spiral grooves formed thereon, at least one film stacked structure formed on a surface of the substrate, an interlayer separating layer, and a light transmitting layer;
each film stacked structures being an independent recording layer structure and including from top to bottom a reflective film, an upper dielectric film, a recording film, a lower dielectric film, and a barrier film; the interlayer separating layer being located between two film stacked structures to isolate them from each other;
characterized in that
an interface film is additionally formed in each of the film stacked structures between the reflective film and the upper dielectric film to achieve improved environmental resistance and electrical characteristics.

2. The recordable optical recording medium as claimed in claim 1, wherein the interface film is made of a ZrO₂-based composite material and has a thickness ranged between 1 nm and 300 nm.

3. The recordable optical recording medium as claimed in claim 1, wherein the recording film is made of a material selected from the group consisting of a metal or a half-metal of copper (Cu), silicon (Si) or chromium (Cr), and an alloy material containing copper (Cu), silicon (Si) or chromium (Cr) as a primary component thereof.

4. The recordable optical recording medium as claimed in claim 1, wherein the substrate is made of a material selected from the group consisting of polycarbonate resin, polymethyl methacrylate, polystyrene resin, polyethylene resin, and polypropylene resin.
